(19) United States
(12) Patent Application Publication
(10) Pub. No.: US 2025/0316195 A1
(43) Pub. Date: Oct. 9, 2025

(54) VARIFOCAL EXTENDED REALITY IMAGE DEVICE AND METHOD FOR PROVIDING IMAGE

(71) Applicant: Electronics and Telecommunications Research Institute, Daejeon (KR)

(72) Inventors: Byung Gyu CHAE, Daejeon (KR); Il Kwon JEONG, Daejeon (KR)

(73) Assignee: Electronics and Telecommunications Research Institute, Daejeon (KR)

(21) Appl. No.: 19/171,568

(22) Filed: Apr. 7, 2025

(30) Foreign Application Priority Data
Apr. 5, 2024 (KR) 10-2024-0046817
Apr. 4, 2025 (KR) 10-2025-0043934

(51) Int. Cl. G09G 3/00; G06F 3/01; G06T 3/40; G06T 15/06; G06T 15/20

(52) U.S. Cl. CPC G09G 3/003; G06F 3/013; G06T 3/40; G06T 15/06; G06T 15/205; G09G 2354/00

(57) ABSTRACT

An extended reality image device according to the embodiment of the present invention includes: an optical system forming plurality of focal planes; a sensor obtaining user gaze information; a processor selecting one of the plurality of focal planes based on the gaze information, changing the focus of the optical system to form focus on the selected focal plane, and generating a binocular disparity focal image; and a display outputting the binocular disparity focal image under the control of the processor, wherein a comfortable viewing zone for the user exists within plurality of depth of fields by the plurality of focal planes formed.

### CROSS REFERENCE TO RELATED APPLICATION

The present application claims priority to a KR application 10-2024-0046817 filed on Apr. 5, 2024, and 10-2025-10-2024-0046817, filed on Apr. 4, 2025, the entire contents of which are incorporated herein for all purposes by this reference.

### BACKGROUND OF THE INVENTION

This disclosure relates to a method for providing binocular disparity focal images using wearable extended reality (XR) image devices.

### DESCRIPTION OF THE RELATED ART

XR (extended reality) devices refer to equipment that utilizes extended reality technology to combine the real and virtual worlds. XR encompasses a broad range of concepts including virtual reality (VR), augmented reality (AR), and mixed reality (MR). This technology provides users with immersive experience and is applied in various industrial sectors.

The key characteristics of XR devices include providing users with 3D environments beyond reality to enhance immersion, tracking user movements and environments to improve interaction and immersion, offering various forms from lightweight AR glasses to highly immersive VR headsets, and utilizing Al and machine learning to generate realistic virtual environments.

### SUMMARY

The purpose of this disclosure is to provide XR imaging technology that can view stereoscopic images stably according to the principle of visual perception, such as a real-life environment, by implementing a variable focus expansion reality image visualization technology that changes the focus by linking the user's viewpoint and reproduces a binocular disparity focal image.

An extended reality image device, including: an optical system forming plurality of focal planes; a sensor obtaining user gaze information; a processor selecting one of the plurality of focal planes based on the gaze information changing the focus of the optical system to form focus on the selected focal plane, and generating a binocular disparity focal image; and a display outputting the binocular disparity focal image under the control of the processor, wherein a comfortable viewing zone for the user exists within a plurality of depth of fields by the plurality of focal planes.

The comfortable viewing zone is defined based on the size of allowable circle of confusion that settles on the retina of a human eye.

Wherein the size of allowable circle of confusion is calculated in advance based on physiological surveys or diffraction relationships.

Wherein the size of allowable circle of confusion is calculated in advance based on average human visual acuity and pupil size.

Wherein the size of the allowable circle of confusion is between 10 micrometers and 15 micrometers.

Wherein the comfortable viewing zone exists within the plurality of depth of fields by the plurality of focal planes.

Wherein the optical system is set to have the comfortable viewing zone to exist within the plurality of depth of fields by the plurality of focal planes.

Wherein the optical system includes a depth-variable lens module for changing the focus.

Wherein the depth-variable lens module includes at least one geometric phase lens that varies the focus of the optical system according to polarization control.

Wherein each geometric phase lens is composed of a birefringence material and forms two focal planes.

Wherein the optical system includes a visualization lens module, which is integrally formed with each geometric phase lens and visualizes the binocular disparity focal image on the selected focal plane.

Wherein the processor generates the binocular disparity focal image by depth rendering.

Wherein the processor uses a pre-trained deep learning model to generate the binocular disparity focal image.

Wherein the deep learning model includes z-buffer algorithms and ray tracing algorithms.

Wherein during training, the deep learning model utilizes dynamic foveated rendering-produced first binocular disparity focal image as input data and outputs second binocular disparity focal image generated based on ray tracing algorithms, and wherein the dynamic foveated rendering includes a rendering operation that forms the center of the binocular disparity focal image with high resolution and the periphery with low resolution.

A method for providing an image in an extended reality image device, comprising: forming, by an optical system of the extended reality image device, plurality of focal planes; obtaining, by a sensor of the extended reality image device, user gaze information; selecting, by a processor of the extended reality image device, one of the focal planes based on the gaze information; changing, by the processor, the focus of the optical system to form focus on the selected focal plane; generating, by the processor, a binocular disparity focal image; outputting, by a display of the extended reality image device, the binocular disparity focal image, wherein a comfortable viewing zone for the user exists within a plurality of depth of fields by the plurality of focal planes.

Wherein the comfortable viewing zone is defined based on the size of allowable circle of confusion that settles on the retina of a human eye.

Wherein the size of allowable circle of confusion is calculated in advance based on physiological surveys or diffraction relationships, and the size of the allowable circle of confusion is between 10 micrometers and 15 micrometers.

Wherein the comfortable viewing zone exists within the plurality of depth of fields by the plurality of focal planes formed by the optical system.

Further comprising: a step of generating the binocular disparity focal image by depth rendering; and a step of generating the binocular disparity focal image using a pre-trained deep learning model that includes z-buffer algorithms and ray tracing algorithms, wherein during training, the deep learning model uses dynamic foveated rendering-produced first binocular disparity focal image as input data and outputs second binocular disparity focal image generated based on ray tracing algorithms, and wherein the dynamic foveated rendering includes a rendering operation that forms the center of the binocular disparity focal image with high resolution and the periphery with low resolution.

According to the present disclosure, eye fatigue of a user viewing a binocular disparity focal image through an extended reality imaging device may be minimized.

In addition, according to the present disclosure, viewers of extended reality imaging devices can stably watch binocular disparity focal images for a long time without viewing fatigue.

In addition, according to the present disclosure, when a user views a binocular disparity focal image, natural viewing is possible as if in a real environment.

In addition, according to the present disclosure, it is possible to easily solve the vergence-accommodation conflict problem that occurs when the vergence distance and focal distance are inconsistent when viewing the extended reality image.

### BRIEF DESCRIPTION OF THE DRAWINGS

FIG. 1 illustrates a flowchart representing the method of providing images in an extended reality image device according to an embodiment of the present invention.

FIG. 2 illustrates a block diagram showing the configuration of the extended reality image device according to the embodiment of the present invention.

FIG. 3 illustrates the vergence distance and focal distance based on a user's gaze while viewing an external object.

FIG. 4 illustrates the issue of mismatch between vergence distance and focal distance in conventional technology.

FIG. 5 illustrates the vergence distance and focal distance according to the embodiment of the present invention.

FIG. 6 illustrates a depth of field according to a user's gaze.

FIG. 7 illustrates the change in distortion size and the comfortable viewing zone based on the viewing distance for the plurality of focal planes generated in the embodiment of the present invention.

FIG. 8 illustrates the configuration of the focusing optical system for the extended reality image device according to the embodiment of the present invention.

FIG. 9 illustrates a visible angle and angle of view and a visible range of an extended reality imaging device according to an embodiment of the present invention.

FIG. 10 illustrates the process of generating binocular disparity focal images using deep learning in the extended reality image device according to the embodiment of the present invention.

FIG. 11 illustrates the process by which the extended reality image device provides binocular disparity focal images based on a user's gaze in the embodiment of the present invention.

### DETAILED DESCRIPTION

### Explanation Of Terms in This Specification

All embodiments described below are exemplarily shown to aid understanding of the present disclosure and may be modified differently from the embodiments described herein to be implemented in various embodiments. In addition, in describing the present disclosure, if it is determined that a detailed description of a related known function or known component may unnecessarily obscure the gist of the present disclosure, the detailed description thereof will be omitted.

To help understand the disclosure, the attached drawings are not shown at the actual scale, but the dimensions of some components may be exaggerated, and when reference numbers are written on each component, the same components are marked with the same code as possible even if they are shown in different drawings.

In addition, terms such as first, second, A, B, (a) and (b) may be used to describe components of embodiments of the present disclosure. These terms are only intended to distinguish the components from other components, and the nature, order, or the like of the corresponding components is not limited by the terms. If a component is stated to be ‘connected’, ‘combined’, or ‘connected’ to another component, that component may be directly connected, coupled, or connected to that other component, but it should be understood that another component may be ‘connected’, ‘combined’ or ‘connected’ between that component and that other component.

Therefore, since the configurations shown in the embodiments and drawings described herein are only the most preferred embodiments of the present disclosure and do not represent all of the technical ideas of the present disclosure, there may be various modified embodiments of the present disclosure.

In addition, terms or words used in this specification and claims should not be limited to ordinary or dictionary meanings, and should be interpreted as meanings and concepts consistent with the technical idea of this disclosure based on the principle that the inventor can properly define the concept of the term to describe his or her disclosure in the best way.

In addition, the singular expression used in this application includes a plurality of expressions unless it means something clearly different in the context.

### Vergence Focus Mismatch Problem of XR Device

This disclosure relates to a varifocal extended reality imaging device, and more specifically, to solve the vergence-accommodation conflict problem that appears in extended reality imaging devices, a method of varying the focus and reproducing binocular disparity focal images in conjunction with the user's viewpoint.

The extended reality (XR) device implements a 3D stereoscopic image using a stereoscopic method, that is, binocular disparity. The user looks at the 2D display virtual image enlarged through an external optical device (or imaging optical system) with both eyes and reconstructs the 3D image by receiving an image with a different perspective from the brain. At this time, the user looks at the 2D display image and the user's focus is focused on the display image plane, but since the image of the 3D object is formed in a part away from the display image plane, a vergence-accommodation conflict (VAC) in which the user's eyes converge and the communication distance (focal distance) do not match occurs.

In this way, unlike when the user views an actual image, since the focal distance and the vergence distance do not match, physiological stimulation (stimuli) matches the vergence distance and the focal distance occurs continuously in the user's two eyes while viewing the stereoscopic image. This phenomenon not only increases the visual fatigue of the user's two eyes but may also cause serious errors in the user's perception of stereoscopic images.

Therefore, we propose below a method to reduce the user's fatigue when viewing using extended reality imaging devices and to solve the vergence-accommodation conflict problem in order to stably watch stereoscopic images for a long time.

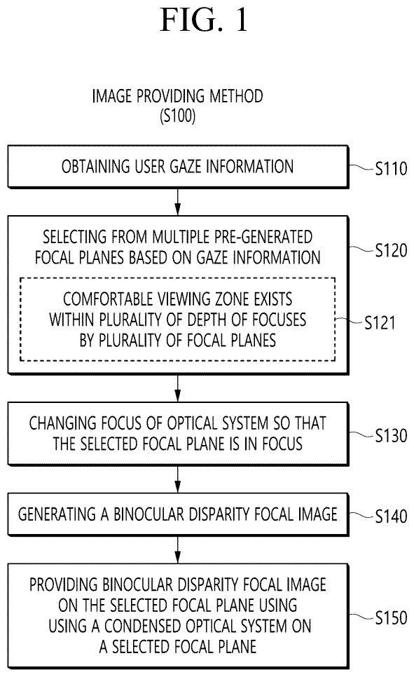

### FIG. 1: Flowchart of Method of Providing Image

FIG. 1 illustrates a flowchart illustrating an image providing method of an extended reality imaging device according to an embodiment of the present invention.

As shown in FIG. 1, an image providing method (S100) of an extended reality imaging device includes steps S110, S120, S130, S131, S140, and S150, and a detailed description thereof is as follows.

First, the extended reality imaging device obtains gaze information of a user (S110).

Here, the extended reality imaging device detects a movement of a user's pupil through a sensor and obtains gaze information based on the movement of the pupil. Here, the extended reality imaging device may detect the movement of a user's pupil through a gaze tracker. Here, the extended reality imaging device may obtain a movement of a user's pupil and obtain a gaze vergence distance of two eyes of the user.

Next, the extended reality imaging device selects one of a plurality of previously generated focal planes based on gaze information (S120).

Here, the comfortable viewing zone is present within a plurality of depth of fields by a plurality of focus planes (S121). A plurality of focus planes forms a depth of field, respectively. Here, an imaging optical system of an extended reality imaging device may be set so that a comfortable viewing zone exists within a plurality of depth of fields formed by a plurality of focus planes.

Focus planes may be formed so that the viewing comfort zone (DOF) exists within the depth of field (DOF) based on the average visual acuity of the human eye at the time of manufacturing or at a specific time after manufacturing the extended reality imaging device. For example, the number of focal planes may be three, but is not necessarily limited thereto.

That is, the variable focus extended reality imaging device according to the prior art forms a large number of focuses within a specific range to solve the vergence-accommodation conflict problem (e.g., 64), and accordingly, the complexity of the variable focus imaging optical system may increase and system resources for focus change may be excessively generated. In contrast, the extended reality imaging device according to the present invention may secure a comfortable viewing zone in which a user feels comfortable watching within a wide range while forming a smaller number of focuses compared to the prior art.

Here, the depth of field is determined according to the size of a circle of confusion (CoC) formed on the retina of the human eye. The allowable circle of confusion size may be determined by a physiological experiment or a light diffraction limit.

The depth of field may be determined as a ±0.3 diopter range with respect to each focal plane, but is not limited thereto, and may have a value range greater than 0.3 diopter.

The depth of field may be interpreted as a vergence-accommodation mismatch. That is, since the comfortable viewing zone exists within the depth of field, a vergence-accommodation conflict (VAC) problem may be solved.

Subsequently, the extended reality imaging device changes the focus of the imaging optical system so that the focus is formed on the selected focal plane (S130).

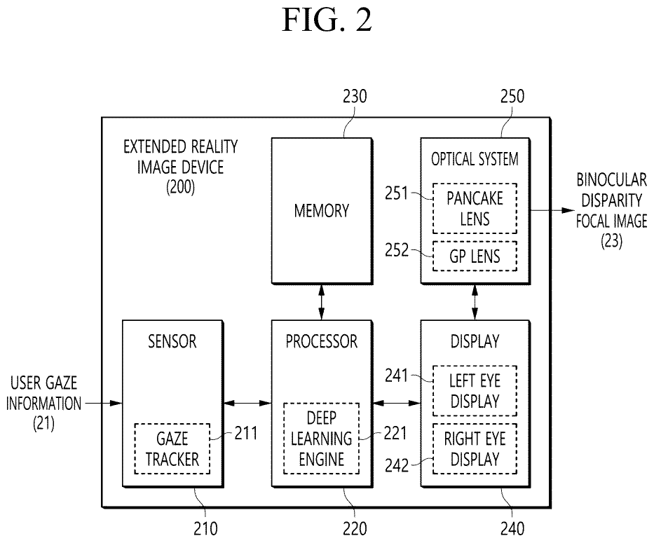

Here, the imaging optical system may also be defined as an optical device or an optical system. The imaging optical system may include a depth variable lens module, a pancake lens module, and a lens control driver. Here, the lens control driver may be replaced with a processor which will be described later with reference to FIG. 2.

Here, the depth variable lens module changes focus by polarization control, and a geometric phase (GP) lens and a polarization control element manufactured using a birefringent material may be formed in a modular form. Here, one GP lens module may form two focal planes. That is, when n GP lenses are used, 2ⁿ focal planes may be formed.

Subsequently, the extended reality imaging device generates a binocular disparity focal image (S140).

Here, the binocular disparity focal image may mean two images provided independently to each of the two eyes of the user.

Next, the extended reality imaging device provides a binocular disparity focal image on the selected focal plane using an imaging optical system (S150).

Here, the pancake lens module may be provided in a form integrated with the GP lens module. For example, the pancake lens module serves to visualize the XR image without distortion with an image viewing distance of 28 cm to 7 meters or more and an angle of view of 110 degrees or more.

### FIG. 2: Extended Reality Image Device Structure

FIG. 2 illustrates a block diagram illustrating a configuration of an extended reality imaging device according to an embodiment of the present invention.

As shown in FIG. 2, the extended reality imaging device 200 may include a sensor 210, a processor 220, a memory 230, a display 240, and an imaging optical system 250.

The sensor 210 may detect gaze information 21 of a user. For example, the sensor 210 may include a gaze tracker 211 for tracking a user's gaze. For example, the gaze tracker 211 may include a camera for photographing both eyes of a user. For example, the gaze tracker 211 may transmit gaze information of both eyes photographed through the camera to the processor 220.

The processor 220 may generate a binocular disparity focal image. The processor 220 may include a deep learning engine 221 for generating a binocular disparity focal image.

In addition, processor 220 may obtain user's gaze information.

In addition, the processor 220 may select one of a plurality of previously generated focal planes based on gaze information.

In addition, the processor 220 may change the focus of the imaging optical system (optical device 250) so that the focus is formed on the selected focal plane.

In addition, the processor 220 may visualize/provide a binocular disparity focal image on the selected focal plane using an imaging optical system.

For example, the processor 220 may control the display 240 to output a pre-generated binocular disparity focal image. For example, the processor 220 may output independent binocular disparity focal images to the front of both eyes of the user using the left-eye display 241 and the right-eye display 242. For example, the processor 220 may control the imaging optical system 250 such that the focus of both eyes of the user is formed on the selected focal plane.

The memory 230 may store instructions for the above-described operations of the processor 220. Also, the memory 230 may store the binocular disparity focal image generated by the processor 220. Also, the memory 230 may store the user's gaze information obtained by the sensor 210.

The display 240 may output a binocular disparity focal image to the front of both eyes of the user. For example, the display 240 may include a left-eye display 241 for outputting a left-eye disparity focal image to the front of the user's left eye and a right-eye display 242 for outputting a right-eye disparity focal image to the front of the user's right eye.

The focus of the imaging optical system 250 may be changed according to the control of the processor 220. For example, the imaging optical system 250 may include a pancake lens 251 and a GP lens 252 capable of changing a focus.

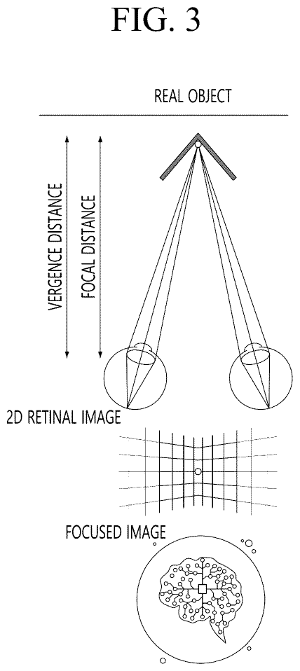

### FIG. 3-5: Vergence Distance vs Focal Distance

FIG. 3 illustrates a vergence distance and a focal distance according to a user's gaze toward an external object.

As shown in FIG. 3, when a user looks at a real object, a projection image of the real object is formed on the 2D retina through the lens of the human eye. In addition, since 2D projection image information formed on the retina of both eyes and having different disparity is transmitted to the visual cortex, the brain may naturally reconstruct and recognize the 3D real object.

In other words, two-dimensional images with different viewpoints formed on micro-scale visual cells of the retina of both human eyes are input, and the human brain naturally reconstructs the three-dimensional image.

When looking at the actual measurement, the vergence distance of the user's two eyes verging and the focal distance of the user's two eyes coincide with the location of the actual measurement.

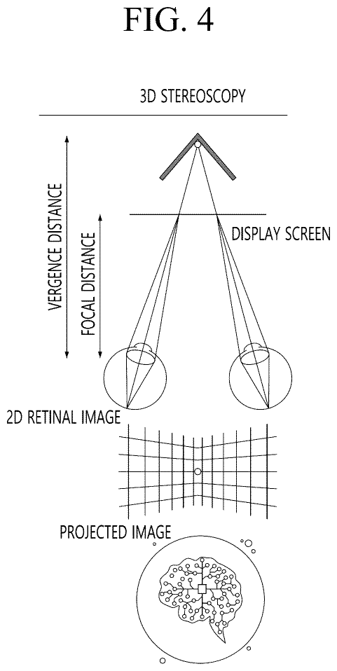

FIG. 4 illustrates a problem of inconsistency between vergence distance and focal distance according to the prior art.

As shown in FIG. 4, in the case of an extended reality imaging device according to the prior art, the user's two eyes focus on the virtual display screen generated by the extended reality imaging device, while the user's two eyes converge elsewhere than the display screen.

That is, in the case of an extended reality imaging device according to the prior art, the focal distance of the user's two eyes and the vergence distance of the user's two eyes are inconsistent with each other.

In addition, in the case of the prior art, a simple projection image is provided to the retina instead of a focal image on the real object. Accordingly, when viewing a stereoscopic image with a binocular disparity focal image, there is a problem of providing a simple projection image rather than a focal image (VAC) and a vergence-accommodation conflict (focal image) on the real object.

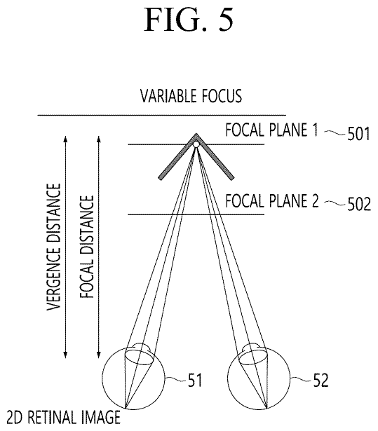

FIG. 5 illustrates a vergence distance and a focal distance according to an embodiment of the present invention.

As shown in FIG. 5, according to an embodiment of the present disclosure, the extended reality imaging device obtains user gaze information, obtains a vergence distance at which the gaze of the user's two eyes 51 and 52 converge based on the user's gaze information, and can change the focus from focal plane 2 (502) to focal plane 1 (501) using an imaging optical system so that the vergence distance and focal distance match.

Accordingly, the extended reality imaging device may generate an environment in which a user sees a real object through a method of providing an intra-retinal focal image while solving a VAC problem using a variable focus imaging technology that tracks a user's gaze and changes the focus. Then, even in a situation where a stereoscopic image is provided to an external imaging optical system, a person is unable to distinguish it from seeing a real object.

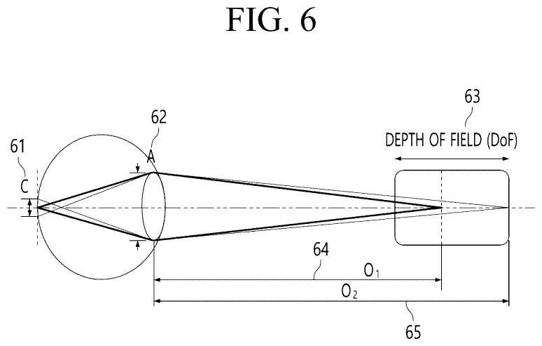

### FIG. 6: Depth of Fields

FIG. 6 illustrates a depth of field according to a user's gaze.

The depth of field may mean a range in which the user can see objects clearly, that is, a range in which the focus of the user's two eyes is aligned. Also, the depth of field 63 may be defined as a depth of field (DOF).

As shown in FIG. 6, since an image of an object is formed on the retina through the lens of the lens of the human eye, the depth of field may be calculated based on the size 61 of the circle of confusion (CoC) formed on the retina of the human eye.

The extended reality imaging device may obtain the depth of field by using Equation 1 below. O₁(64) is the distance between the focal plane where the object is located and the two eyes, c is the size of the circle of confusion, f is the focal distance of the human eye, and A(62) is the size of the pupil.

The extended reality imaging device may obtain a depth of field by changing the O₂ 65.

$$c = A \frac{\vert {O}_{2} - {O}_{1} \vert}{{O}_{2}} \frac{f}{{O}_{1} - f} \qquad [ EQUATION 1 ]$$

The size of the allowable circle of confusion formed on the retina of the human eye may be calculated in advance from the physiological irradiation or the light diffraction limit. Physiologically, when visual acuity with 1 arcmin angular resolution is defined as 1.0, and when the pupil size A is set to 2-3 mm, the allowable circle of confusion size is 10 to 15 μm.

As shown in FIG. 6, the depth of field narrows at a short distance within about 1 meter, and in this case, a blurring phenomenon of an image formed in both eyes clearly appears when the focus is off. On the contrary, the depth of field is very wide at a relatively long distance and is focused on the entire area like a pinhole camera.

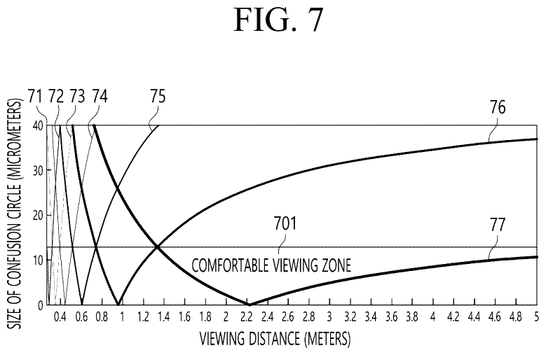

### FIG. 7: Changes in the Size of the Circle of Confusion According to Plurality of Focal Planes

FIG. 7 illustrates a change in the size of a circle of confusion and a comfortable viewing zone according to a viewing distance of a plurality of focal planes generated in an embodiment of the present invention.

As shown in FIG. 7, the extended reality imaging device may previously generate a plurality of focus planes 71, 72, 73, 74, 75, 76, and 77.

For example, the size of the circle of confusion formed in the user's two eyes varies depending on the user's viewing distance for each of the plurality of focal planes generated by extended reality imaging devices and having different focal distances.

When the size of the allowable circle of confusion is set to 13 μm, the focal plane present in the comfortable viewing zone 701 (the area where the circle of confusion size is within the allowable size) changes as the user's viewing distance (the vergence distance of the user's two eyes) changes.

When the user's gaze converges within a specific range (e.g., from 28 cm to 7 m), a plurality of focal planes may be formed in advance so that the size of the circle of confusion exists within the allowable circle of confusion size in all areas within the specific range (where the depth of field exists in the comfortable viewing zone). A plurality of focal planes may be set at the time of manufacturing the extended reality imaging device or arbitrarily set after manufacturing the extended reality imaging device but are not necessarily limited thereto.

For example, the depth of field may be determined as a ±0.3 diopter (D) range with respect to each focal plane. That is, in the ±0.3 diopter focus depth range, the comfortable viewing zone exists within the depth of field. In other words, it solves the vergent focus mismatch (VAC) problem.

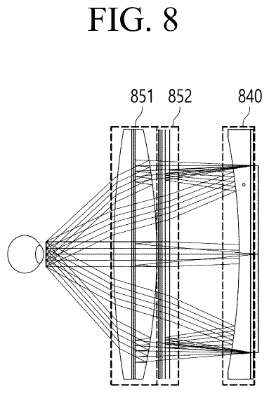

### FIG. 8: Imaging Optical System

FIG. 8 illustrates a configuration of an imaging optical system of an extended reality imaging device according to an embodiment of the present invention.

As shown in FIG. 8, the imaging optical systems 851 and 852 are located in front of the eyes of the user. The imaging optical systems 851 and 852 may change the focus of the eyes of the user. The imaging optical system may be configured in a modularized form of the pancake lens 851 and the depth variable lens 852. The imaging optical system may be provided in a state in which the pancake lens 851 and the depth variable lens 852 overlap in parallel.

The imaging optical systems 851 and 852 may be driven by a processor (the processor 220 of FIG. 2) or a lens control unit (or a lens driving unit) (not shown) provided adjacent to the imaging optical system.

The focus of the depth variable lens 852 is varied by polarization control, and may be composed of a geometric phase (GP) lens made of a birefringent material and a polarization control element. For example, a depth variable lens may have two focal planes. For example, when an extended reality imaging device includes n depth variable lenses, the extended reality imaging device may form 2ⁿ focal planes using n depth variable lenses.

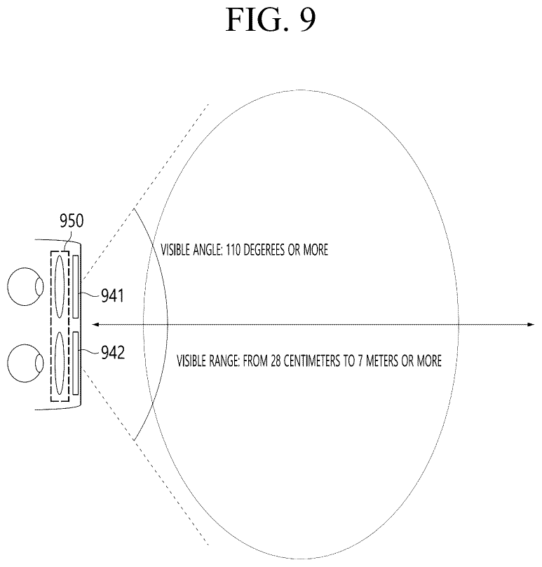

### FIG. 9: Visible Angle and Range of Image

FIG. 9 illustrates a visible angle and angle of view and a visible range of an extended reality imaging device according to an embodiment of the present invention.

As shown in FIG. 9, the imaging optical system 950 of FIG. 9 may be configured such that the pancake lens 851 of FIG. 8 is integrated with the depth variable lens 852.

Here, the imaging optical system 950 may form a visible distance of about 28 cm to more than 7 m by using micro-display images of the left and right eyes 941 and 942. Also, the imaging optical system 950 may form an angle of view of 110° or more.

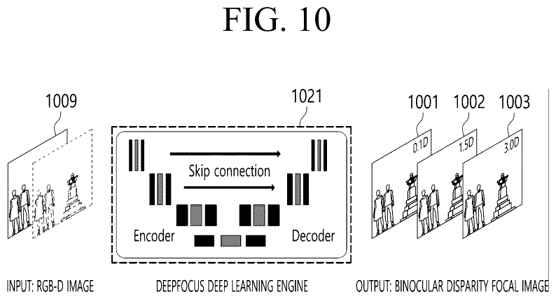

### FIG. 10: Rendering Binocular Disparity Focal Image

FIG. 10 illustrates a process of generating a binocular disparity focal image using deep learning by an extended reality imaging device according to an embodiment of the present invention.

The processor 220 of the extended reality imaging device (the processor 220 of FIG. 2) may perform DOF rendering that generates a binocular disparity focal image. Examples of DOF rendering may include a z-buffer algorithm and a ray-tracing algorithm.

For example, the processor 220 may generate plurality of binocular disparity focal images (1001, 1002, 1003) with different focuses as outputs by inputting the RGB-D image (1009) into the deep learning engine (1021) included in the processor.

For example, the processor 220 may obtain user gaze information, generate a central portion of an image in relatively high quality, and process a peripheral portion of the image in relatively low quality. Here, as described above, a rendering technology that processes a central image quality of an image and a peripheral image quality of an image differently may be defined as a dynamic foveated rendering technology.

As shown in FIG. 10, the extended reality imaging device may train a deep focus deep learning engine 1021 in advance. For example, the extended reality imaging device may use an RGB-D binocular image dataset generated by ray-tracking-based dynamic foveated rendering as input data. In addition, for example, the extended reality imaging device may use the RGB binocular image dataset generated through DOF rendering as output data.

Here, the deep learning engine may use a convolution-based deep learning algorithm such as U-Net according to the prior art or may be used by modifying a deep learning algorithm.

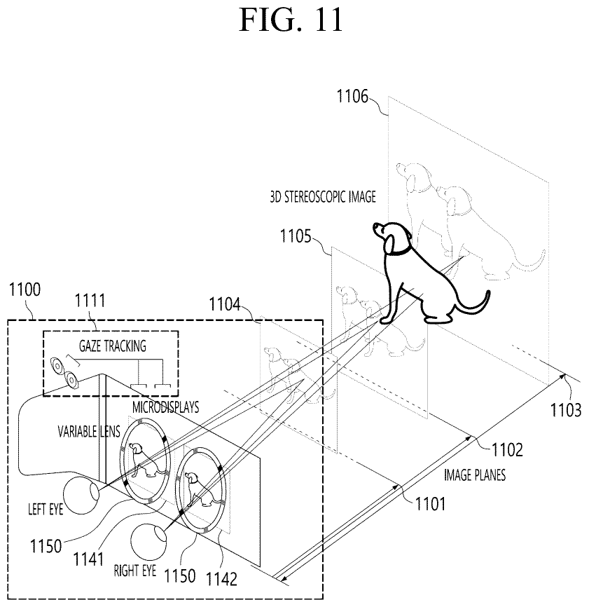

### FIG. 11: Providing Binocular Disparity Focal Image

FIG. 11 illustrates a process of providing a binocular disparity focal image according to a user's gaze by an extended reality imaging device according to an embodiment of the present invention.

As shown in FIG. 11, the extended reality imaging device 1100 obtains gaze information of a user through a sensor 1111.

The extended reality imaging device 1100 may display a pre-generated binocular disparity focal image (binocular focal image) through the left-eye display 1141 and the right-eye display 1142.

The extended reality imaging device 1100 forms a plurality of focal planes 1101, 1102, and 1103 for allowing the vergence distance of the user's two eyes to exist within the comfortable viewing zone based on the user's gaze information.

The extended reality imaging device 1100 may select a focal plane based on the current user's gaze and control the imaging optical system (variable lens) 1150 so that the focal point of the user's two eyes is formed on the focal plane.

Here, the user's viewpoint may be tracked in real time through a gaze tracker. For example, the gaze tracker may measure a runaway angle with respect to a user's main viewpoint with accuracy of 0.6 degrees or more.

### How to Interpret this Specification

Although the embodiments of the present disclosure have been described in more detail with reference to the accompanying drawings, the present disclosure is not limited to this embodiment and may be variously modified without departing from the technical idea of the present disclosure.

Therefore, the embodiments disclosed in the present disclosure are intended to illustrate and not limit the technical idea of the present disclosure, and the scope of the technical idea of the present disclosure is not limited by this embodiment. Therefore, it should be understood that the embodiments described above are illustrative in all respects and are not limited. The scope of protection of the present disclosure should be interpreted by the following claims, and all technical ideas within the equivalent scope should be construed as being included in the scope of the present disclosure.

What is claimed is:

1. An extended reality image device, including:
an optical system forming plurality of focal planes;
a sensor obtaining user gaze information;
a processor selecting one of the plurality of focal planes based on the gaze information changing the focus of the optical system to form focus on the selected focal plane, and generating a binocular disparity focal image; and
a display outputting the binocular disparity focal image under the control of the processor,
wherein a comfortable viewing zone for the user exists within a plurality of depth of fields by the plurality of focal planes.

2. The extended reality image device of claim 1,
wherein the comfortable viewing zone is defined based on the size of allowable circle of confusion that settles on the retina of a human eye.

3. The extended reality image device of claim 2,
wherein the size of allowable circle of confusion is calculated in advance based on physiological surveys or diffraction relationships.

4. The extended reality image device of claim 3,
wherein the size of allowable circle of confusion is calculated in advance based on average human visual acuity and pupil size.

5. The extended reality image device of claim 4,
wherein the size of the allowable circle of confusion is between 10 micrometers and 15 micrometers.

6. The extended reality image device of claim 1,
wherein the comfortable viewing zone exists within the plurality of depth of fields by the plurality of focal planes.

7. The extended reality image device of claim 6,
wherein the optical system is set to have the comfortable viewing zone to exist within the plurality of depth of fields by the plurality of focal planes.

8. The extended reality image device of claim 1,
wherein the optical system includes a depth-variable lens module for changing the focus.

9. The extended reality image device of claim 8,
wherein the depth-variable lens module includes at least one geometric phase lens that varies the focus of the optical system according to polarization control.

10. The extended reality image device of claim 9,
wherein each geometric phase lens is composed of a birefringence material and forms two focal planes.

11. The extended reality image device of claim 10,
wherein the optical system includes a visualization lens module, which is integrally formed with each geometric phase lens and visualizes the binocular disparity focal image on the selected focal plane.

12. The extended reality image device of claim 1,
wherein the processor generates the binocular disparity focal image by depth rendering.

13. The extended reality image device of claim 12,
wherein the processor uses a pre-trained deep learning model to generate the binocular disparity focal image.

14. The extended reality image device of claim 13,
wherein the deep learning model includes Z-buffer algorithms and ray tracing algorithms.

15. The extended reality image device of claim 14,
wherein during training, the deep learning model utilizes dynamic foveated rendering-produced first binocular disparity focal image as input data and outputs second binocular disparity focal image generated based on ray tracing algorithms,
and wherein the dynamic foveated rendering includes a rendering operation that forms the center of the binocular disparity focal image with high resolution and the periphery with low resolution.

16. A method for providing an image in an extended reality image device, comprising:
forming, by an optical system of the extended reality image device, plurality of focal planes;
obtaining, by a sensor of the extended reality image device, user gaze information;
selecting, by a processor of the extended reality image device, one of the focal planes based on the gaze information;
changing, by the processor, the focus of the optical system to form focus on the selected focal plane;
generating, by the processor, a binocular disparity focal image;
outputting, by a display of the extended reality image device, the binocular disparity focal image,
wherein a comfortable viewing zone for the user exists within a plurality of depth of fields by the plurality of focal planes.

17. The method of claim 16,
wherein the comfortable viewing zone is defined based on the size of allowable circle of confusion that settles on the retina of a human eye.

18. The method of claim 17,
wherein the size of allowable circle of confusion is calculated in advance based on physiological surveys or diffraction relationships,
and the size of the allowable circle of confusion is between 10 micrometers and 15 micrometers.

19. The method of claim 16,
wherein the comfortable viewing zone exists within the plurality of depth of fields by the plurality of focal planes formed by the optical system.

20. The method of claim 16, comprising:
a step of generating the binocular disparity focal image by depth rendering;
and a step of generating the binocular disparity focal image using a pre-trained deep learning model that includes Z-buffer algorithms and ray tracing algorithms,
wherein during training, the deep learning model uses dynamic foveated rendering-produced first binocular disparity focal image as input data and outputs second binocular disparity focal image generated based on ray tracing algorithms,
and wherein the dynamic foveated rendering includes a rendering operation that forms the center of the binocular disparity focal image with high resolution and the periphery with low resolution.
